(19) United States
(12) Patent Application Publication
(10) Pub. No.: US 2023/0344720 A1
(43) Pub. Date: Oct. 26, 2023

(54) HIGH-RESOLUTION OPTICAL BACKSCATTER METHOD TO DISCOVER PHYSICAL TOPOLOGY OF COMPLEX, INTERCONNECTED FIBER OPTIC NETWORK AND AUTOMATICALLY MONITOR AND TROUBLESHOOT ITS PERFORMANCE

(71) Applicant: TELESCENT INC., Irvine, CA (US)

(72) Inventors: Anthony Stephen Kewitsch, Costa Mesa, CA (US); Bucoveanu Ramiro Voicu, Geneva (CH)

(73) Assignee: TELESCENT INC., Irvine, CA (US)

(21) Appl. No.: 17/795,875

(22) PCT Filed: Feb. 1, 2021
(86) PCT No.: PCT/US2021/016112

§ 371 Date: Jul. 28, 2022

Related U.S. Application Data
(60) Provisional application No. 62/969,405, filed on Feb. 3, 2020.

(51) Int. Cl. H04L 41/12; H04B 10/071; H04L 43/50

(52) U.S. Cl. CPC H04L 41/12; H04B 10/071; H04L 43/50

(57) ABSTRACT

High-resolution optical backscatter system and method to discover the end-to-end physical topology of complex, interconnected fiber optic network, and to automatically monitor and troubleshoot its performance. Each passive cable element has unique, substantially unchanging optical backscatter signature based on microscopic random imperfections of the glass core along the length of the optical fiber, measurable along the length of the optical fiber using an optical reflection meter. The resulting signature is a two dimensional array of data points (or trace) corresponding to the optical backreflection signal strength as a function of length. When multiple cables are interconnected to produce a link, the corresponding traces of the multiple cables are concatenated to produce a composite trace for the entire link. The composite trace is compared to the traces of individual cables and the series of cables comprising the link and the serial relationship in which they are interconnected is thereby determined.

### CROSS-REFERENCE TO RELATED APPLICATIONS

This application claims the benefit of U.S. provisional application No. 62/969,405, filed Feb. 3, 2020, the entire contents of which are hereby fully incorporated herein by reference for all purposes.

### COPYRIGHT STATEMENT

This patent document contains material subject to copyright protection. The copyright owner has no objection to the reproduction of this patent document or any related materials in the files of the United States Patent and Trademark Office, but otherwise reserves all copyrights whatsoever.

### BACKGROUND

Data centers are highly interconnected with 100,000 or more physical cables in a typical data center. Cables connecting servers, switches, storage devices, routers, patch-panels, cross-connects, monitoring and transmission equipment and the like form a complex, passive physical network that must be installed, tested, managed, tracked, monitored, repaired and reconfigured over the lifetime of the data center. The complexity of this “fiber plant” results in management challenges, a painstaking installation and troubleshooting process, and a long Time-To-Repair (TTR).

Optical fiber cables are passive devices that are not able to be tracked by present means without adding significant cost and complexity. Conventional tracking solutions require complex, non-standard cables with electronic identification means that are costly and not scalable. Therefore, the present mode of operation is limited to printed labels and/or RFID tags, which result in a highly manual and error-prone physical interconnect management process. The RFID approach adds cost and requires the addition of RFID reader hardware, for example, as disclosed in U.S. Pat. Nos. 8,554,033 and 9,188,748, and U.S. Published Patent Application No. 20200005001 (application Ser. No. 16/504,166) to Kewitsch. In some implementations, non-standard fiber optic connectors and/or cables are necessary.

An approach to automate these management steps is becoming increasing important as data center operators face increasing complexity at scale to provide very high availability services, with short TTR, while also reducing operating costs.

A system and method to automatically identify fiber optic cables and their end-to-end connectivity to other standard cables and devices, without adding significant cost, is extremely valuable.

### SUMMARY

The present invention is specified in the claims as well as in the below description.

These features along with additional details of the invention are described further in the examples herein, which are intended further to illustrate the invention but are not intended to limit its scope in any way.

We disclose an approach in which one or more optical backscatter measurement devices can be switched onto any one of a large number of optical fiber network links, to perform optical backscatter measurements with high spatial resolution along the length of each link. The optical backscatter signal along the length of optical cables provides a unique identifier for each cable.

In some exemplary aspects, a physical network link with a proximal and distal end consists of one or more interconnected cable elements each with their own proximal and distal ends. The first of the interconnected cables is connected to an optical backscatter measurement apparatus at the proximal end of link, and the last of interconnected cables is unterminated or terminated at an optical transceiver at the distal end of link. Each cable element has its own unique optical backscatter signature, characterized, e.g., by the optical Rayleigh backscatter strength of each particular cable along its length. The unique variation of the Rayleigh backscatter signal along the cable originates from the substantially random distribution and strength of optical backscatter centers along the optical fiber core, each center corresponding to one or more microscopic defects or imperfections in the glass structure.

In a particular example, the optical backscatter measurement apparatus is an Optical Time-Domain Reflectometer (OTDR) with centimeter spatial resolution and a range of 2,000 m to 200 km, or alternatively an Optical Coherence-Domain Reflectometer (OCDR) with 10 micron spatial resolution and a range of 100 m. These are only two examples and there are wide range of measurement apparatus with different resolution, range, optical power, pulse width and wavelength that are commercially available and suitable for this approach. The OTDR is ideal to characterize the optical backscatter signature of each cable element, the cable elements having a length typically in the range of 1 to 2,000 m for links spanning a large data center. The OCDR is ideal to characterize the optical backscatter signature of each transceiver port, with an optical path length in the range of 1 to 10 mm. The transceiver typically includes a ferrule/fiber assembly, a lens and a photodetector or an isolator and laser. The location and strength of each reflection provides a unique backscatter identifier which may be used, e.g., to identify the cable or device.

In a further example, the network links may be terminated at an automated patch-panel or automated cross-connect that is instrumented with one or more optical backscatter measurement devices. Suitable automated patch-panels and automated cross-connect systems are disclosed by the present inventor, e.g., in U.S. Pat. Nos. 8,068,715, 8,463,091, 8,488,938, 8,805,155, 9,52,465, 9,0524,909, 411,108, 9,703,060, 10,042,122, 10,345,526, and 10,649,149. These systems may use a robot to switch in a fiber cross-connect attached to the backscatter measurement device and connect it to any link attached to the automated patch-panel or automated cross-connect system. The large port count of this system enables all links to be connected to the measurement device. Measurements may also be performed by physically connecting the optical backscatter measurement device to the link. Alternatively, if the links have pre-installed optical tap splitters, the tap output connected to the measurement device, then each link may be measured in situ without the need to first disconnect and then connect to the measurement device, which interrupts the data flow.

One general aspect includes obtaining a digital signature for an optical fiber cable and using the digital signature to identify the optical fiber cable, where the digital signature may include an optical backscatter signature for the optical fiber cable at one or more wavelengths, from one or both ends.

Implementations may include one or more of the following features, alone or in combination(s):
The method where the digital signature is stored in a database of digital signatures, a particular digital signature of the digital signatures corresponding to a particular optical fiber cable.
The method where each digital signature in the database is unique in the database.
The method where a given digital signature in the database may include an optical backscatter signature for a corresponding given optical fiber cable at one or more wavelengths, from one or both ends of the given optical fiber.
The method where the method may include, for an optical link comprising a sequence of multiple optical fiber cable segments connected in series, using digital signatures in the database to determine the optical fiber cable segments in the optical link.
The method where the database also includes one or more connector digital signatures of a corresponding one or more fiber optic connectors, and where the method further may include also using at least one connector digital signature to determine the optical fiber cable segments in the optical link.

Another general aspect includes using a plurality of digital optical fiber cable signatures to determine or evaluate aspects of an interconnected fiber optic network. The method also includes where a given signature may include an optical backscatter signature for a corresponding given optical fiber cable at one or more wavelengths, from one or both ends of the given optical fiber.

Implementations may include one or more of the following features, alone or in combination(s):
The method where aspects of the interconnected fiber optic network may comprise one or more of: a physical topology of the interconnected fiber optic network; and/or performance of the interconnected fiber optic network.
The method where the method may include: providing a database of the plurality of digital optical fiber cable signatures.
The method where using also uses one or more connector digital signatures of a corresponding one or more fiber optic connectors to determine or evaluate aspects of the interconnected fiber optic network.

Another general aspect includes a method of determining a signature of an optical link. The optical link may comprise a sequence of multiple optical fiber cable segments connected in series. The method also includes measuring an optical backscatter signature for the optical link at one or more wavelengths, from one or both ends. The method also includes matching the signature of the optical link to signatures of optical fiber cable segments stored in a memory. The method also includes, based on the matching, determining the sequence of multiple optical fiber cable segments along the optical link.

Implementations may include one or more of the following features, alone or in two or more combination(s):
The method where the signatures of optical fiber cable segments stored in the memory were determined by: measuring an optical backscatter signature for a plurality of individual optical fiber cable segment at one or more wavelengths, from one or both ends; and storing signatures of individual optical fiber cable segments and their associated unique identifiers and related metadata in memory.
The method where signatures of optical fiber cable segments stored in the memory were determined by: measuring an optical backscatter signature for a plurality of individual optical fiber cable segment at one or more wavelengths, from one or both ends; and storing signatures of individual optical fiber cable segments and their associated unique identifiers and related metadata in memory.
The method where the signature of the optical link comprises a unique backscatter signature.
The method further comprising: measuring an optical backscatter signature for each optical port of a plurality of optical transceiver elements at one or more wavelengths, and storing signatures of individual optical transceiver elements and their associated unique identifiers and related metadata in the memory.
The method further comprising: matching the signature of the optical link to the signature of a transceiver element stored in the memory; and, based on the matching, determining the identifier of a transceiver element terminating the optical link.
The method, further comprising: determining physical lengths of the optical link and of the cable segments, and storing the physical lengths in the metadata.
The method further comprising: determining optical insertion loss of the optical link and the cable segments, and storing in the metadata.
The method further comprising: determining optical return loss of the optical link and the cable segments and storing in the metadata.
The method where the optical link further comprises one or more fiber optic connectors.
The method where the determining also uses one or more connector digital signatures of a corresponding one or more fiber optic connectors to determine the sequence of multiple optical fiber cable segments along the optical link.
The method where the method may include: determining physical lengths of the optical link and of the cable segments, and storing the physical lengths in the metadata.
The method where the method may include determining optical insertion loss of the optical link and the cable segments, and storing in the metadata.
The method where the method may include determining optical return loss of the optical link and the cable segments and storing in the metadata.
The method where the signature of the optical link may include a unique backscatter signature.
The method where the method may include measuring an optical backscatter signature for each optical port of each of a plurality of optical transceiver element at one or more wavelengths, and storing signatures of individual optical transceiver elements and their associated unique identifiers and related metadata in the memory.
The method where the method may include matching the signature of the optical link to the signature of a transceiver element stored in the memory; and, based on the matching, determining the identifier of a transceiver element terminating the optical link.

Another general aspect includes a method including obtaining a signature of an optical link, where the optical link may include a connected sequence of components, the components including multiple optical fiber cable segments. The method also includes, based on the signature of the optical link and a plurality of component signatures, determining concatenated components that comprise the optical link. The method also includes where a plurality of component signatures were determined for a corresponding plurality of components, and where the components comprise a first plurality of optical fiber cable segments.

Implementations may include one or more of the following features, alone or in two or more combination(s):
The method where the optical link is connected to or comprises a transceiver having at least one optical port, and wherein the components include a second plurality of optical ports, and wherein the component signatures comprise signatures of the second plurality of optical ports.
The method may include determining an identifier of a transceiver element terminating the optical link using the signatures of the second plurality of optical ports.
The method where obtaining the signature of an optical link may include measuring an optical backscatter signature for the optical link at one or more wavelengths, from one or both ends.
The method where the component signature for a particular component of the plurality of components was determined by measuring an optical backscatter signature for the particular component at one or more wavelengths, from one or both ends.
The method where the optical link further comprises one or more fiber optic connectors.
The method where the determining also uses one or more connector digital signatures of a corresponding one or more fiber optic connectors to determine components that comprise the optical link.

Another general aspect includes a method of discovering a physical topology of a highly interconnected network of optical fiber cables. The method also includes configuring one or more automated optical switches to connect one or more optical backscatter measurement devices to the optical fiber cables of the interconnected network. The method also includes measuring and storing a sampled representation of an optical backscatter signature of each optical fiber cable at one or more optical wavelengths. The method also includes measuring and storing a sampled representation of a composite optical backscatter signature of each optical fiber cable in the network at one or more optical wavelengths. The method also includes correlating the composite optical backscatter signature with stored optical backscatter signatures for the constituent optical fiber cables, to identify a cable and the cable's location within the interconnected network.

Implementations may include one or more of the following features, alone or in two or more combination(s):
The method may include where the correlating identifies each cable and their location within the interconnected network.
The method may include: generating a physical connectivity map of the network.
The method may include: generating a heat map of insertion loss for the interconnected network.
The method may include where at least some of the optical fiber cables are connected by a corresponding one or more fiber optic connectors.
The method where one or more optical wavelengths are in spectral windows about 1310 nm, 1550 nm or 1625 nm.
The method where an optical backscatter signature is measured with a spatial resolution along the fiber of 0.1 mm to 10 mm.

Another general aspect includes a method of troubleshooting network connectivity along a physical network link after a network is deployed. The method of troubleshooting network connectivity also includes measuring a composite optical backscatter signature of the link at one or more optical wavelengths and storing the signature and associated metadata in a database. The method also includes correlating the composite optical backscatter signature with a stored database of backscatter signatures for the constituent cable segments, to determine an end-to-end, serial relationship of constituent cable segments along the link, stored as connectivity data. The method also includes comparing the connectivity data with previously stored connectivity data. The method also includes (i) identifying a location along the link at which the connectivity data changed from a previous measurement and (ii) determining if a change corresponds to a particular constituent cable segment connector, a insertion loss event (e.g., a high insertion loss event), a cut, bend or stressed cable segment.

Implementations may include one or more of the following features, alone or in two or more combination(s):
The method may include: determining an optical insertion loss of the link from the optical backscatter signature.
The method may include: determining an optical return loss of the link from the optical backscatter signature.
The method wherein the link also comprises one or more fiber optic connectors.
The method wherein the correlating also uses one or more connector digital signatures of a corresponding one or more fiber optic connectors to determine the end-to-end, serial relationship of constituent cable segments along the link.

Another general aspect includes a method of diagnosing swapped transmit and receive lines in a transmission link. The method also includes measuring a composite optical backscatter signature of a physical network link at one or more optical wavelengths. The method also includes correlating the composite optical backscatter signature with a stored database of backscatter signatures of optical transceiver elements. The method also includes, based on the correlating, identifying whether a distal port is the transmit or receive line.

Implementations may include one or more of the following features, alone or in two or more combination(s):
The method where the database may include backscatter signatures of ports of optical transceiver elements.
The method may include: based on the measuring, if measurement indicates that the transmit and receive lines are reversed, instructing an automated patch-panel attached to the physical network link to swap transmit and receive lines.
The method wherein the link also comprises one or more fiber optic connectors.
The method wherein the correlating also uses one or more connector digital signatures of a corresponding one or more fiber optic connectors to identify whether the distal port is the transmit or receive line.

Other embodiments of these aspects include corresponding computer systems, apparatus, and computer programs recorded on one or more computer storage devices, each configured to perform the actions of the methods.

Another general aspect includes an automated fiber optic cable discovery and mapping system. The system also includes a multiplicity of fiber optic cables connected serially and end-to-end. The system also includes a processing unit. The system also includes an optical reflectometer unit. The system also includes a database that may include cable reflection records, each cable reflection record including a unique identifier and a reflection trace may include optical reflection strength as a function of longitudinal distance along the cable. The system also includes a matching algorithm to identify location and end-to-end relationship of concatenated cables based on matching their concatenated reflection traces.

Implementations may include one or more of the following features, alone or in two or more combination(s):
The system may include: an optical switching system to selectively connect the optical reflectometer unit onto any of the multiplicity of fiber optic cables.
The system may include a robotic fiber optic patch-panel system providing passive, low insertion loss physical fiber optic connections between the optical reflectometer unit and any of the multiplicity of fiber optic cables.

Another general aspect includes a data center interconnect system providing high bandwidth data transmission links between network elements including one or more of the network elements including routers, switches and computers. The system providing high bandwidth data transmission links also includes a multiplicity of optical fiber links. Each optical fiber link may include a multiplicity of cable segments. The links also include each cable segment characterized by a unique Rayleigh backscatter signature represented by a two dimensional array of optical reflection values as a function of longitudinal distance from a first connector of the cable segment and extending to a second connector of the cable segment. The links also include the backscatter signature and associated metadata for each cable segment stored within a database.

Implementations may include one or more of the following features, alone or in two or more combination(s):
The system may include: a reflectometer selectively connectable to one of the links, where the reflectometer measures the Rayleigh backscatter signature along the entire link.
The system may include: a processing unit to match the Rayleigh backscatter signature along the entire link to the cable segments and to determine end-to-end connectivity of the cable segments.
The system wherein at least some of the optical fiber links also comprises one or more corresponding fiber optic connectors.

Another general aspect includes a method comprising, for at least one particular link of a plurality of physical network links in a network, each link comprising one or more constituent optical cable segments, determining a corresponding composite optical backscatter signature. The method further comprises (B) comparing one or more backscatter signatures determined to previously determined backscatter signatures for the network. And the method further comprises, (C) based on the comparing in (B), determining whether there has been a change in connectivity or configuration of the network.

Implementations may include one or more of the following features, alone or in two or more combination(s):
The method may include identifying a location or link within the network that has changed.
The method where a link also comprises one or more fiber optic connectors.

Another general aspect includes a method comprising (A) obtaining a digital signature for an optical fiber cable; and (B) comparing the digital signature obtained in (A) to a previously determined digital signature for the optical fiber cable; and, (C) based on the comparing in (B), determining whether the fiber optic cable has been modified or damaged since the previously determined digital signature was determined.

Implementations may include one or more of the following features, alone or in two or more combination(s):
The method where the digital signature comprises an optical backscatter signature for the optical fiber cable at one or more wavelengths, from one or both ends.
The method where the previously determined digital signature was determined and/or provided by the optical fiber cable manufacturer.

Implementations of the described techniques may include hardware, a method or process, or computer software on a computer-accessible medium.

Below is a list of process (or method) embodiments. Those will be indicated with the letters “P.” Whenever such embodiments are referred to, they will be done by referring to “P” embodiments.
P1. A method comprising:
obtaining a digital signature for an optical fiber cable; and
using the digital signature to identify the optical fiber cable, wherein
the digital signature comprises an optical backscatter signature for the optical fiber cable at one or more wavelengths, from one or both ends.
P2. The method of embodiment(s) P1, wherein the digital signature is stored in a database of digital signatures, a particular digital signature of the digital signatures corresponding to a particular optical fiber cable.
P3. The method of any of embodiment(s) P1-P2, wherein each digital signature in the database is unique in the database.
P4. The method of any of embodiment(s) P1-P3, wherein a given digital signature in the database comprises an optical backscatter signature for a corresponding given optical fiber cable at one or more wavelengths, from one or both ends of the given optical fiber.
P5. The method of any of embodiment(s) P1-P3, further comprising:
for an optical link comprising a sequence of multiple optical fiber cable segments connected in series, using digital signatures in the database to determine the optical fiber cable segments in the optical link.
P6. The method of any of embodiment(s) P1-P5, wherein the database also includes one or more connector digital signatures of a corresponding one or more fiber optic connectors, and where the method further comprises also using at least one connector digital signature to determine the optical fiber cable segments in the optical link.
P7. A method comprising:
using a plurality of digital optical fiber cable signatures to determine or evaluate aspects of an interconnected fiber optic network,
wherein a given signature comprises an optical backscatter signature for a corresponding given optical fiber cable at one or more wavelengths, from one or both ends of the given optical fiber.
P8. The method of embodiment(s) P7, wherein the aspects of the interconnected fiber optic network comprise one or more of: a physical topology of the interconnected fiber optic network; and/or performance of the interconnected fiber optic network.
P9. The method of any of embodiment(s) P7-P8, further comprising: providing a database of the plurality of digital optical fiber cable signatures.
P10. The method of any of embodiment(s) P7-P9, wherein the using also uses one or more connector digital signatures of a corresponding one or more fiber optic connectors to determine or evaluate aspects of the interconnected fiber optic network.
P11. A method of any of determining a signature of an optical link, the optical link comprising a sequence of multiple optical fiber cable segments connected in series, the method comprising:
measuring an optical backscatter signature for the optical link at one or more wavelengths, from one or both ends;
matching the signature of the optical link to signatures of optical fiber cable segments stored in a memory; and
based on the matching, determining the sequence of multiple optical fiber cable segments along the optical link.
P12. The method of embodiment(s) P11, wherein the signatures of optical fiber cable segments stored in the memory were determined by:
measuring an optical backscatter signature for a plurality of individual optical fiber cable segment at one or more wavelengths, from one or both ends; and
storing signatures of individual optical fiber cable segments and their associated unique identifiers and related metadata in memory.
P13. The method of any of embodiment(s) P11-P12, wherein the signature of the optical link comprises a unique backscatter signature.
P14. The method of any of embodiment(s) P11-P13, further comprising:
measuring an optical backscatter signature for each optical port of a plurality of optical transceiver elements at one or more wavelengths, and storing signatures of individual optical transceiver elements and their associated unique identifiers and related metadata in the memory.
P15. The method of any of embodiment(s) P11-P14, further comprising:
matching the signature of the optical link to the signature of a transceiver element stored in the memory; and,
based on the matching, determining the identifier of a transceiver element terminating the optical link.
P16. The method of any of embodiment(s) P11-P15, further comprising:
determining physical lengths of the optical link and of the cable segments, and storing the physical lengths in the metadata.
P17. The method of any of embodiment(s) P11-P16, further comprising: determining optical insertion loss of the optical link and the cable segments, and storing in the metadata.
P18. The method of any of embodiment(s) P11-P17, further comprising: determining optical return loss of the optical link and the cable segments and storing in the metadata.
P19. The method of any of embodiment(s) P11-P18 wherein the optical link further comprises one or more fiber optic connectors.
P20. The method of any of embodiment(s) P11-P19, wherein the determining also uses one or more connector digital signatures of a corresponding one or more fiber optic connectors to determine the sequence of multiple optical fiber cable segments along the optical link.
P21. A method comprising:
obtaining a signature of an optical link, the optical link comprising a connected sequence of components, the components including multiple optical fiber cable segments; and
based on the signature of the optical link and a plurality of component signatures, determining components that comprise the optical link, wherein
a plurality of component signatures were determined for a corresponding plurality of components, and where the components comprise a first plurality of optical fiber cable segments.
P22. The method of embodiment(s) P21, wherein the optical link is connected to or comprises a transceiver having at least one optical port, and wherein the components include a second plurality of optical ports, and wherein the component signatures comprise signatures of the second plurality of optical ports.
P23. The method of any of embodiment(s) P21-P22, further comprising:
determining an identifier or a transceiver element terminating the optical link using the signatures of the second plurality of optical ports.
P24. The method of any of embodiment(s) P21-P23, wherein obtaining the signature of an optical link comprises: measuring an optical backscatter signature for the optical link at one or more wavelengths, from one or both ends.
P25. The method of any of embodiment(s) P21-P24, wherein the component signature for a particular component of the plurality of components was determined by: measuring an optical backscatter signature for the particular component at one or more wavelengths, from one or both ends.
P26. The method of any of embodiment(s) P21-P25 wherein the optical link further comprises one or more fiber optic connectors.
P27. The method of any of embodiment(s) P21-P26, wherein the determining also uses one or more connector digital signatures of a corresponding one or more fiber optic connectors to determine components that comprise the optical link.
P28. A method of determining or discovering a physical topology of a highly interconnected network of optical fiber cables, the method comprising:
configuring one or more automated optical switches to connect one or more optical backscatter measurement devices to the optical fiber cables of the interconnected network;
measuring and storing a sampled representation of an optical backscatter signature of each optical fiber cable at one or more optical wavelengths;
measuring and storing a sampled representation of a composite optical backscatter signature of optical fiber cables in the network at one or more optical wavelengths; and
correlating the composite optical backscatter signature with stored optical backscatter signatures for constituent optical fiber cables, to identify a cable and the cable's location within the interconnected network.
P29. The method of embodiment(s) P28, wherein the correlating identifies each cable and their location within the interconnected network.
P30. The method of any of embodiment(s) P28-P29, further comprising: generating a physical connectivity map of the network.
P31. The method of any of embodiment(s) P28-P30 further comprising: generating a heat map of insertion loss for the interconnected network.
P32. The method of any of embodiment(s) P28-P31, wherein at least some of the optical fiber cables are connected by a corresponding one or more fiber optic connectors.
P33. The method of any of embodiment(s) P28-P32, wherein the one or more optical wavelengths are in spectral windows about 1310 nm, 1550 nm or 1625 nm.
P34. The method of any of embodiment(s) P28-P33, wherein an optical backscatter signature is measured with a spatial resolution along the fiber of 0.1 mm to 10 mm.
P35. A method of troubleshooting network connectivity along a physical network link after a network is deployed, the network link comprising constituent cable segments, the method comprising:
measuring a composite optical backscatter signature of the link at one or more optical wavelengths and storing the signature and associated metadata in a database;
correlating the composite optical backscatter signature with a stored database of backscatter signatures for the constituent cable segments, to determine an end-to-end, serial relationship of constituent cable segments along the link, stored as connectivity data;
comparing the connectivity data with previously stored connectivity data;
based on the comparing,
(i) identifying a location along the link at which the connectivity data changed from a previous measurement; and
(ii) determining if a change corresponds to a particular constituent cable segment connector, an insertion loss event, a cut, bend or stressed cable segment.
P36. The method of embodiment(s) P35, further comprising:
determining an optical insertion loss of the link from the optical backscatter signature.
P37. The method of any of embodiment(s) P35-P36, further comprising:
determining an optical return loss of the link from the optical backscatter signature.
P38. The method of any of embodiment(s) P35-P37, wherein the link also comprises one or more fiber optic connectors.
P39. The method of any of embodiment(s) P35-P38, and wherein the correlating also uses one or more connector digital signatures of a corresponding one or more fiber optic connectors to determine the end-to-end, serial relationship of constituent cable segments along the link.
P40. A method of diagnosing swapped transmit and receive lines in a transmission link, the method comprising:
measuring a composite optical backscatter signature of a physical network link at one or more optical wavelengths;
correlating the composite optical backscatter signature with a stored database of backscatter signatures of optical transceiver elements; and,
based on the correlating, identifying whether a distal port is the transmit or receive line.
P41. The method of embodiment(s) P40, wherein the database comprises backscatter signatures of ports of optical transceiver elements.
P42. The method of any of embodiment(s) P40-P41, further comprising: based on the measuring, if measurement indicates that the transmit and receive lines are reversed, instructing an automated patch-panel attached to the physical network link to swap transmit and receive lines.
P43. The method of any of embodiment(s) P40-P42, wherein the link also comprises one or more fiber optic connectors.
P44. The method of any of embodiment(s) P40-P43, and wherein the correlating also uses one or more connector digital signatures of a corresponding one or more fiber optic connectors to identify whether the distal port is the transmit or receive line.
P45. A method comprising:
(A) for at least one particular link of a plurality of physical network links in a network, each link comprising one or more constituent optical cable segments, determining a corresponding composite optical backscatter signature;
(B) comparing one or more backscatter signatures determined in (A) to previously determined backscatter signatures for the network; and,
(C) based on the comparing in (B), determining whether there has been a change in connectivity or configuration of the network.
P46. The method of embodiment(s) P45, further comprising identifying a location or link within the network that has changed.
P47. The method of any of embodiment(s) P45-P46, wherein the link also comprises one or more fiber optic connectors.
P48. A method comprising:
(A) obtaining a digital signature for an optical fiber cable;
(B) comparing the digital signature obtained in (A) to a previously determined digital signature for the optical fiber cable; and,
(C) based on the comparing in (B), determining whether the fiber optic cable has been modified or damaged since the previously determined digital signature was determined.
P49. The method of embodiment(s) P48, wherein the digital signature comprises an optical backscatter signature for the optical fiber cable at one or more wavelengths, from one or both ends.
P50. The method of any of embodiment(s) P48-P49, wherein the previously determined digital signature was determined and/or provided by the optical fiber cable manufacturer.

Below is a list of system embodiments. Those will be indicated with the letters “S.” Whenever such embodiments are referred to, they will be done by referring to “S” embodiments.
S51. An automated fiber optic cable discovery and mapping system comprising:
a multiplicity of fiber optic cables connected serially and end-to-end;
a processing unit;
an optical reflectometer unit;
a database comprising cable reflection records, each cable reflection record including a unique identifier and a reflection trace comprising optical reflection strength as a function of longitudinal distance along the cable; and
a matching algorithm to identify location and end-to-end relationship of cables based on matching reflection traces.
S52. The system of embodiment(s) S51, further comprising: an optical switching system to selectively connect the optical reflectometer unit onto any of the multiplicity of fiber optic cables.
S53. The system of any of embodiment(s) S51-S52, wherein the optical switching system comprises a robotic fiber optic patch-panel system providing passive, low insertion loss physical fiber optic connections between the optical reflectometer unit and any of the multiplicity of fiber optic cables.
S54. A data center interconnect system providing high bandwidth data transmission links between network elements including one or more of the network elements including routers, switches, servers, storage devices, optical fiber and optical transport equipment, wherein interconnect system comprises:
a multiplicity of optical fiber links;
at least some of the optical fiber links are comprised of a corresponding multiplicity of cable segments;
each cable segment characterized by a unique Rayleigh backscatter signature represented by a two dimensional array of optical reflection values as a function of longitudinal distance from a first connector of the cable segment and extending to a second connector of the cable segment; and
the backscatter signature and associated metadata for each cable segment stored within a database.
S55. The system of embodiment(s) S54, further comprising: a reflectometer selectively connectable to one of the links, wherein the reflectometer measures the Rayleigh backscatter signature along the entire link.
S56. The system of any of embodiment(s) S54-S55, further comprising: a processing unit to match the Rayleigh backscatter signature along the entire link to the cable segments and to determine end-to-end connectivity of the cable segments.
S57. The system of any of embodiment(s) S54-S56, wherein at least some of the optical fiber links also comprises one or more corresponding fiber optic connectors.

Any of the process embodiments may operate alone or in combination(s) with any of the other process embodiments. Any of the system embodiments may operate alone or in combination(s) with any of the other system embodiments. Any of the process embodiments may operate in combination(s) with any of the system embodiments.

### Glossary and Abbreviations

As used herein, unless used otherwise, the following terms or abbreviations have the following meanings:
OCDR means Optical Coherence Domain Reflectometer;
OFDR means Optical Frequency Domain Reflectometer;
OTDR means Optical Time-Domain Reflectometer;
RFID means Radio Frequency identification; and
TTR means Time-To-Repair.

The term “mechanism,” as used herein, refers to any device(s), process(es), service(s), or combination thereof. A mechanism may be implemented in hardware, software, firmware, using a special-purpose device, or any combination thereof. A mechanism may be integrated into a single device or it may be distributed over multiple devices. The various components of a mechanism may be co-located or distributed. The mechanism may be formed from other mechanisms. In general, as used herein, the term “mechanism” may thus be considered shorthand for the term device(s) and/or process(es) and/or service(s).

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 illustrates aspects of an overlay of two measurements of an optical backscatter signal for a link with four cable elements, as measured from opposite ends of the link;

FIGS. 2A-2B are diagrams of an optical link in which the cross-connect swaps the transmit (Tx) and receive (Rx) lines to fix a link that is down;

FIG. 3 is a diagram of an optical link comprised of multiple transceivers and cable elements, connected at a central location to an automated cross-connect instrumented with an OTDR and/or OCDR, with the OTDR attached to one fiber of the link and with a potential cable fault along a link;

FIG. 4 is a diagram of an optical link comprised of multiple transceivers and cable elements, connected at a central location to an automated cross-connect instrumented with an OTDR and/or OCDR, with the OTDR attached to another fiber of the link;

FIG. 5 is a block diagram of aspects of an optical backscatter cable discovery system according to exemplary embodiments hereof;

FIG. 6 depicts data structures used by a system according to exemplary embodiments hereof;

FIGS. 7A-7E are flowcharts showing operation of a system according to exemplary embodiments hereof; and

FIG. 8 shows aspects of a computer system upon which embodiments hereof may be implemented and carried out.

### DETAILED DESCRIPTION OF THE PRESENTLY PREFERRED EXEMPLARY EMBODIMENTS

We disclose a technique to uniquely identify optical fiber segments and how they are connected, based on the unique and relatively constant Rayleigh backscatter signature of optical fiber as measured using an optical reflectometer. Each fiber segment may be represented as a two-dimensional array of points, giving optical backreflection signal strength as a function of length and providing a unique fingerprint. Subsequent measurement(s) of the fiber segment, typically as part of a serial arrangement with other cables, enables the identity of the fiber segment to be ascertained.

The measured fingerprints are relatively constant over time, temperature and before/after installation. Extreme bends or fiber breaks are distinguishable, appearing as localized signal events at a particular location, further enabling locations of damage to be identified. Note that even in the presence of these localized events, the identity of the fiber may typically still be determined.

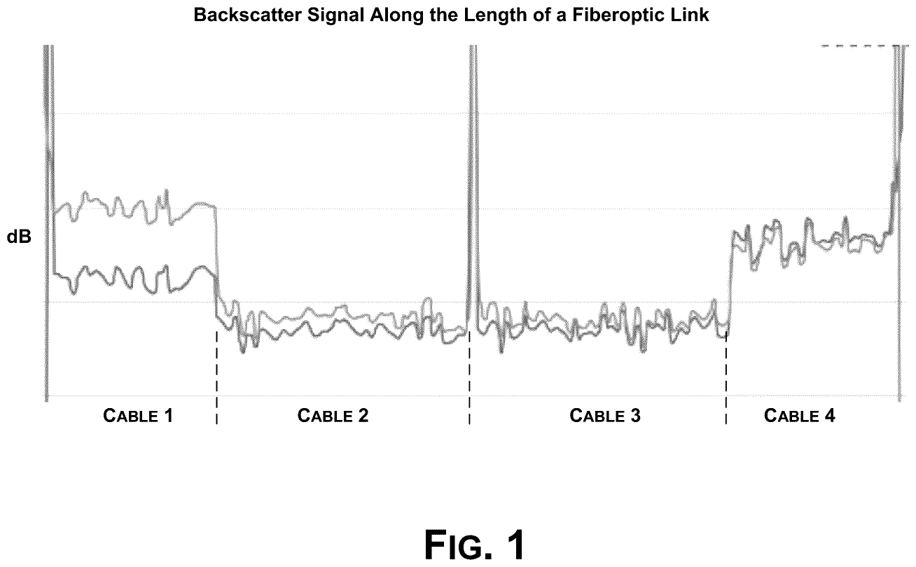

FIG. 1 is an example of the measured composite backreflection trace for a link with four cable elements. Two measurements performed at different times and from different directions are overlaid for comparison to illustrate the unique signatures of each cable element. The data in this example are measured using an OTDR at 1625 nm with 5 ns pulse width and about 10 mW peak power. Note that the backscatter signature is substantially independent of the baseline offset of the measurements and the signature is extracted from the small variations in the signal strength along the length.

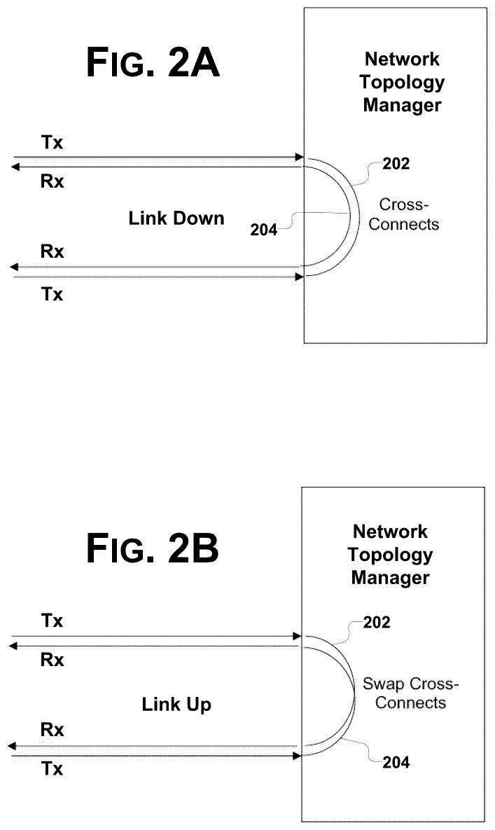

FIGS. 2A-2B illustrate aspects of an example in which two links 202, 204 connected to an automated fiber cross-connect system, in FIG. 2A the transmit (Tx) and receive (Rx) are incorrectly swapped (Tx connected to Tx, Rx connected to Rx), and so the link is down. In the FIG. 2B this is corrected by the automated fiber cross-connect system so that Tx's are connected to Rx's and the link is up.

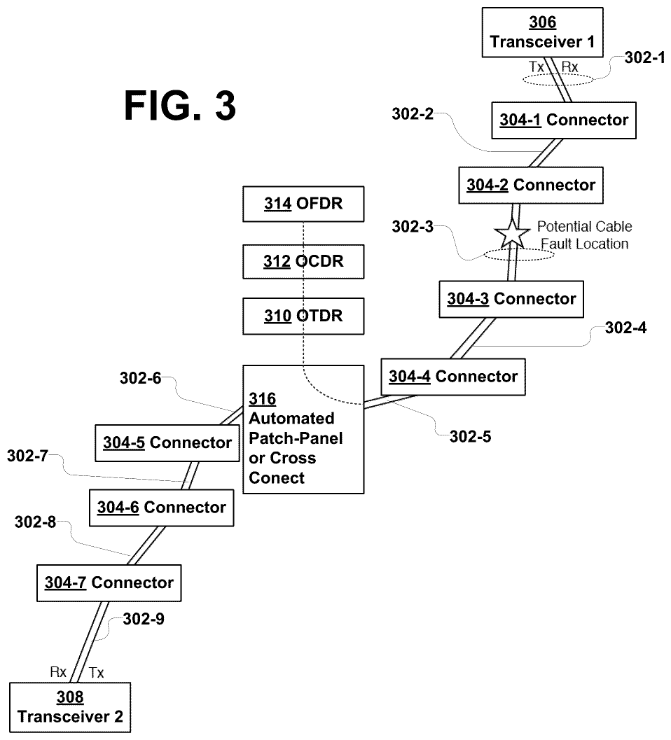

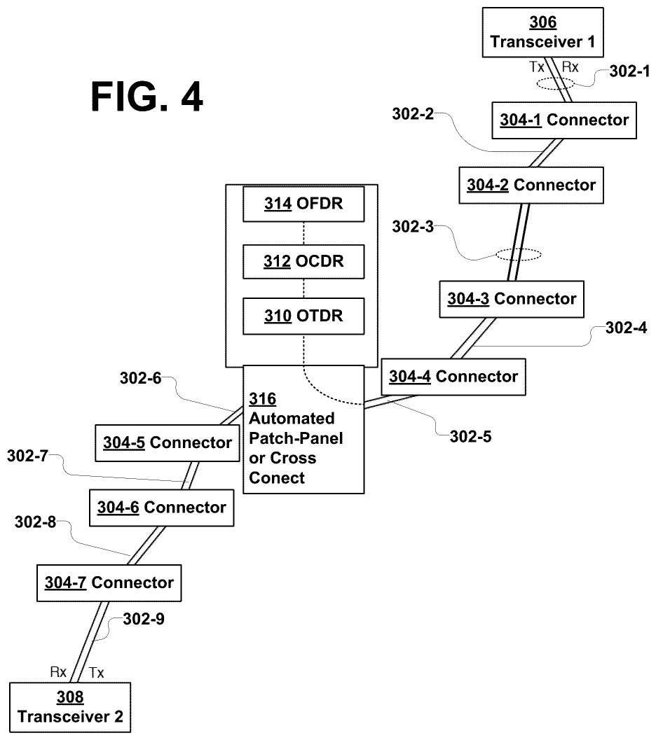

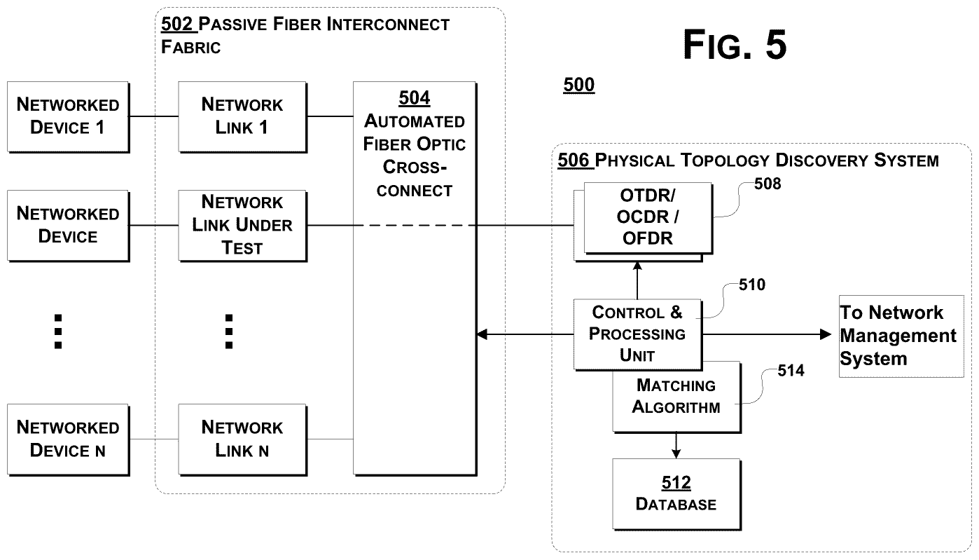

FIGS. 3 and 4 illustrate aspects of an example fiber optic link 300 consisting of a multiplicity of serial interconnected cable elements 302-1 . . . 302-9 (individually and collectively cable element 302) with connectors 304-1 . . . 304-7 extending between transceivers 1 and 2 (306, 308). In the drawings, a cable elements 302 are labeled in pairs. Thus, e.g., cable element 302-1 includes a transmit (Tx) cable and a receive (Rx) cable.

An OTDR 310 or OCDR 312 or OFDR 314, for example, may be used (e.g., via an automated patch-panel or cross-connect 316) to launch a measurement signal into the link 300 towards transceiver 1 306. The characteristics of the backreflected signal may be used to identify, for example, a fault within one of the cable elements.

In the example in FIGS. 3 and 4, there is a potential cable fault in the cable element(s) 302-3 connecting connectors 304-2 and 304-3.

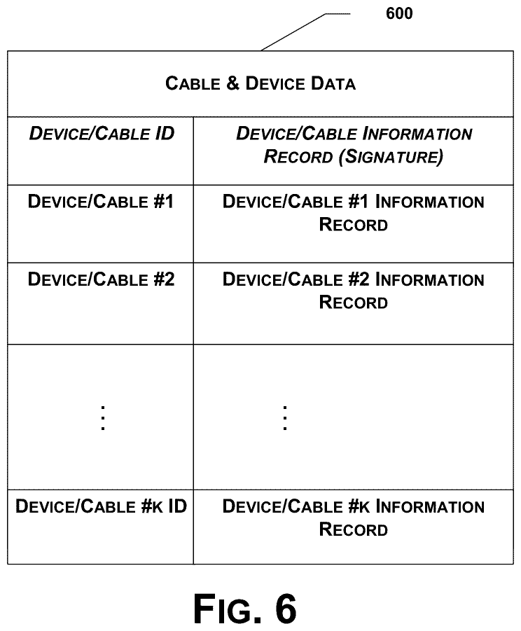

FIG. 5 is a block diagram showing aspects of a passive fiber interconnect discovery system 500 according to exemplary embodiments hereof. The passive fiber interconnect fabric 502 is comprised of a multiplicity of networked devices (e.g., servers, switches, routers, etc.) connected by network links passing through an automated fiber optic cross-connect 504. The connectivity of the interconnect fabric 502 is discoverable with the addition of a physical topology discovery system 506 able to be connected to any network link through the automated fiber optic cross-connect. The discovery system 506 uses a measurement device 508 (e.g., an OTDR and/or OCDR and/or OFDR), to launch a measurement signal down any of the optical fibers. A controller and processing unit 510 instructs the cross-connect to select a link and instructs the measurement device 508 (e.g., OTDR and/or OCDR and/or OFDR) to perform a scan and return a measurement trace that is stored within a database 512 and compared by a matching algorithm 514 to pre-measured backreflection signatures for each cable segment within the network link.

Assume, e.g., that the network link under test consists of one or more cable segments connected end-to-end. An optical switch connects the measurement device 508 (e.g., reflectometer, OTDR, OCDR) to the specific link to be tested. The system is controlled by the control and processor unit 510, with a matching algorithm that accesses and matches trace records in the database 512 with the trace measurement taken by the measurement device 508 (reflectometer/OTDR/OCDR).

For a link comprised of multiple cable segments joined in series, the cable segments are typically connected with low loss fiber optic connectors such as the LC, SC, FC, CS, MU, MPO and MTP type. Depending on the connector ferrule polish type (i.e. PC—Physical Polish, UPC—Ultra-physical Polish, APC—Angle Polish), there is a discrete backreflection event localized at the location of the physical connection of the cable segments. This discrete connector backreflection event has a typical strength of −30 dB to −70 dB and is generally at a higher level than the backreflection traces. For multiple cable segments joined in series, the composite backreflection trace will include the concatenated backreflection signatures of each cable segment, with stronger, discrete connector backreflection events separating each of the concatenated backreflection signatures. In a particular example, these discrete connector backreflection events can indicate the ends of each cable segment, thereby aiding in the identification of the signature and matching of the signature to the database of stored signatures.

Rayleigh Backscatter in Single Mode Optical Fiber

Rayleigh scattering is caused by small-scale (small compared with the wavelength of the light in the optical fiber, e.g. 850 nm, 1310 nm, 1550 nm) inhomogeneities that are produced during the optical fiber fabrication process and vary along the length of the optical fiber. Examples of inhomogeneities are glass compositional variations (which results in small, localized refractive index changes) and density variations. Rayleigh scattering typically accounts for a majority of the attenuation in optical fiber.

As light propagates within the optical fiber core, it interacts with silica molecules in the core which partially scatter the light. If the light is scattered at a relatively large angle, the angle being determined by the numerical aperture of the optical fiber, it is diverted out of the core and attenuation occurs. Some scattered light is reflected back toward the light source. OTDRs detect this scattered light signal and perform analysis to determine insertion loss, backreflection and length of the optical fiber. The backscattered optical power spatially averaged over length scales on the order of mm shows a unique variation along the length of the optical fiber.

Optical Reflectometer

An optical time-domain reflectometer (OTDR) is an optoelectronic instrument that launches pulses of light and detects the return signal as a function of time. For example, an OTDR may inject a series of optical pulses into the fiber under test and extracts, from the same end of the fiber, light that is reflected backwards, including the Rayleigh backscatter of the glass fiber, as well as light that is reflected from fiber optic connectors or cracks in the fiber. The scattered or reflected light that is gathered back may be used to produce the backreflection signature or backreflection trace for that fiber.

Similarly, an optical coherence domain reflectometer (OCDR) and/or optical frequency domain reflectometer (OFDR) can also be used to measure the backreflection signature. Typical OTDRs produced by manufacturers such as Exfo, Viavi, Anritsu and Adva are able to measure optical insertion loss and return loss, with 1 dB accuracy and 1 mm resolution.

Optical Data Links

As used herein, an optical link or optical data link is made up of multiple connected components, generally in series. The components may be fiber optic cables or cable segments, optical ports, etc. A link may connect components (e.g., servers, optical connectors, switches, storage devices, routers, patch-panels, cross-connects, monitoring and transmission equipment and the like) of a network.

Each component of an optical link has a unique signature (e.g., determined by an OTDR or the like), and a link has a unique signature which is a function of its component's signatures.

Database

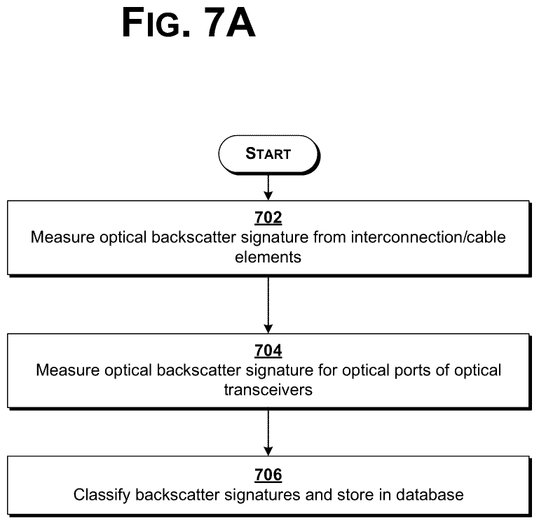

The database 512 may include a number of data structures. An exemplary data structure 600 is shown in FIG. 6, storing cable and device signatures and, optionally, information or metadata about each cable and device such as insertion loss, return loss, length and fiber type. Metadata refers to the descriptive fields that accompany the trace data. This further includes, for example, manufacturer, connector type and index of refraction of the optical fiber cable.

Process for Passive Cable Discovery

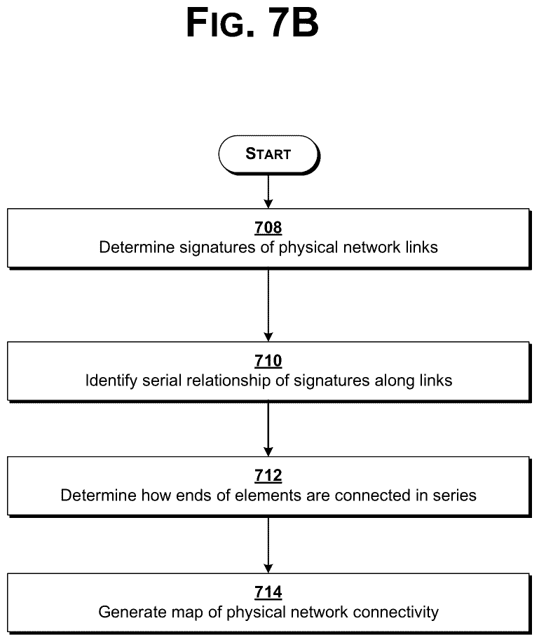

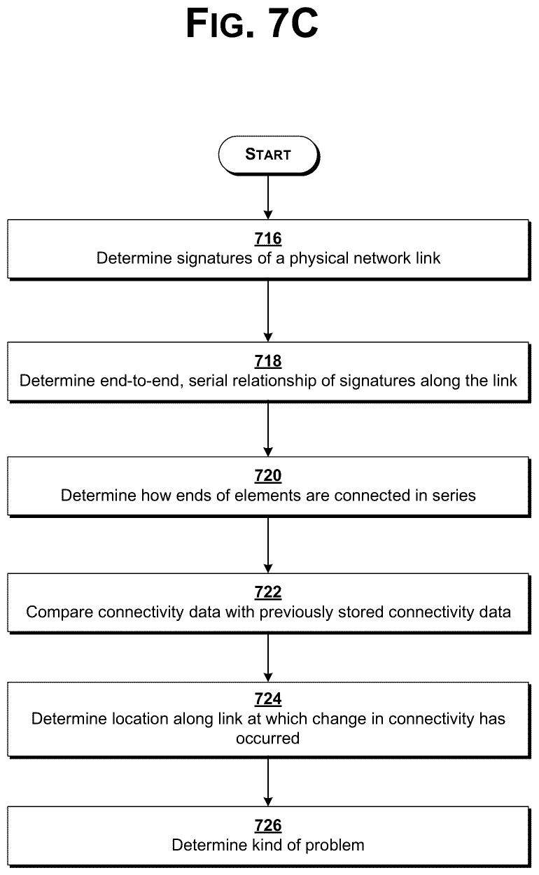

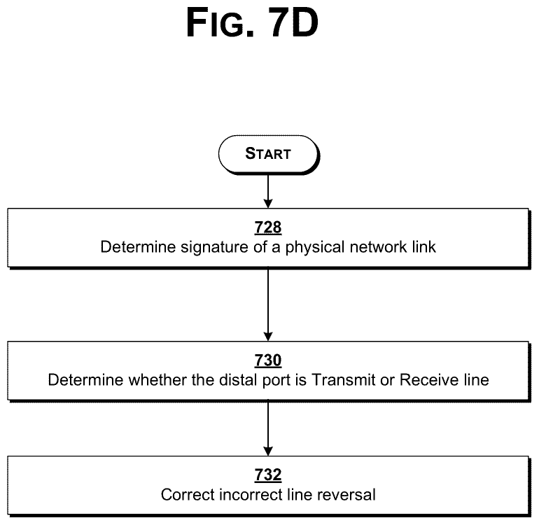

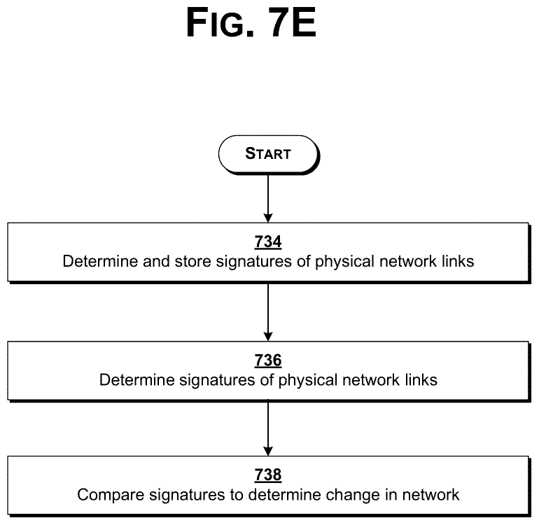

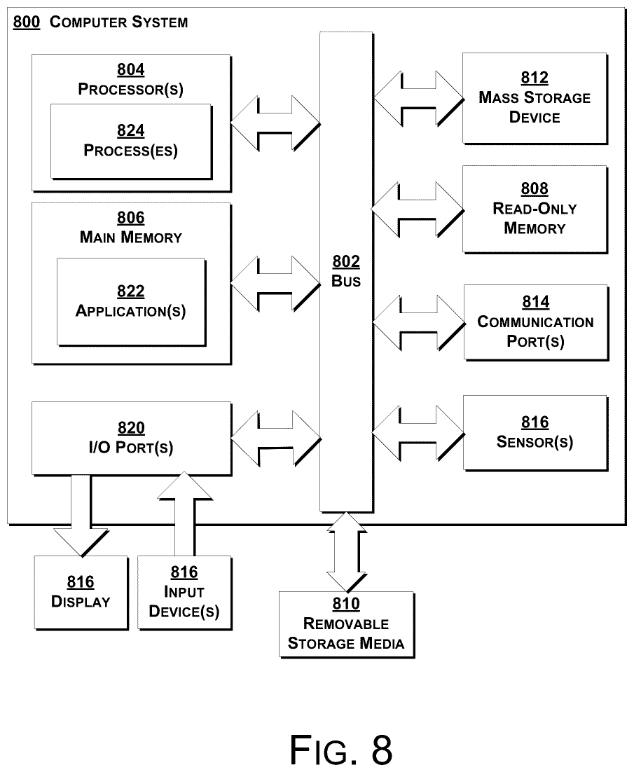

An example of the method to discover cables and their end-to-end connectivity is described next with respect to the exemplary system 500 shown in FIG. 5, the data structure shown in FIG. 6, and the flowcharts in FIGS. 7A-7D. The first step is to characterize the optical backscatter signature of each individual cable element with unique number/identifier (which may be used, e.g., as a serial number).

Initial Measurements Prior to Interconnecting Network

With reference to the flowchart in FIG. 7A, initial measurements of each interconnection/cable element and optical port may be made as follows:
1. Measure optical backscatter signature from each interconnection/cable element at one or more wavelengths, from one or both ends (at 702).
2. Measure optical backscatter signature for each optical port of each optical transceiver element at one or more wavelengths (at 704).
3. Classify each backscatter signature and store in a database (at 706).

Once these signatures are measured and stored within the database 512, they can be used for subsequent discovery of which cable is connected to what, as described in the process below, and with reference to the flowchart in FIG. 7B,

Physical Topology Discovery at Time of Network Cable Installation
1. Determine signatures of physical network links: Measure composite optical backscatter signature of each physical network link at one or more optical wavelengths (at 708).
2. Identify serial relationships of signatures along the links: Correlate composite optical backscatter signature with the stored database of backscatter signatures for the constituent interconnection/cables elements and ports of optical transceiver elements, to identify the serial relationship of each signature along the link (at 710). This may be done, e.g., by application of a machine learning algorithm.
3. Determine how ends of elements are connected in series: Extract the data of how the distal and proximal ends of each element are connected to one another in series (at 712).
4. Based on data, generate the map of physical network connectivity (at 714).

During and after installation, troubleshooting of the link may be necessary for a subset of links. This process is outlined below with reference to the flowchart in FIG. 7C.

Troubleshooting After Network is Deployed
1. Determine signature of a physical network link (at 716): Measure composite optical backscatter signature of a physical network link at one or more optical wavelengths.
2. Determine end-to-end, serial relationship of signatures along the link (at 718). For example, through a machine learning matching algorithm, correlate composite optical backscatter signature with the stored database of backscatter signatures for the constituent interconnection/cable elements and optionally for the ports of optical transceiver elements, to determine the end-to-end, serial relationship of each signature along the link.
3. Determine how ends of elements are connected in series (at 720). E.g., Extract the data of how the distal and proximal ends of each element are connected to one another in series.
4. Compare the connectivity data with the previously stored connectivity data (at 722).
5. Determine location along link at which change in connectivity has occurred (at 724): Identify the location along the link in which a change in connectivity from previous measurement occurs.
6. Determine kind of problem (at 726): Analyze data to determine if this change corresponds to a disconnected cable, a high insertion loss event, a cable cut, bent or stressed cable, etc.

One common outcome of troubleshooting is a determination that the Tx and Rx fiber optic lines may be swapped (incorrectly). A measurement of the backreflection strength from the optical transceiver can be used to distinguish the Tx port (typically terminated in a laser diode) from the Rx port (typically terminated in a photodiode). According to the industry standard 100G CWDM4 2 km spec, the reflectance of transmitter port is typically −12 dB and the reflectance of the receiver port is typically −26 dB.

Diagnosing Swapped Transmit and Receive Lines

Diagnosing incorrectly swapped transmit and receive lines may be done as follows, with reference to the flowchart in FIG. 7D:
1. Determine the signature of a physical network link (at 728): e.g., measure composite optical backscatter signature of the physical network link at one or more optical wavelengths.
2. Determine whether the distal port is the Transmit or Receive line (at 730): e.g., through a machine learning algorithm, correlate the composite optical backscatter signature with the stored database of backscatter signatures for the distal port of optical transceiver elements, to identify whether the distal port is the Transmit or Receive line.
3. Correct incorrect line reversal (at 732): e.g., if the measurement indicates that the Transmit and Receive lines are reversed, instruct an automated patch-panel attached to the physical network link to reverse Transmit and Receive lines and correct the problem.

Using Digital Signatures for Security Checking

A cable's digital signature will likely change if a fiberoptic tap is inserted into the cable. Accordingly, if a link (comprising one or more fiber optic cables) is tapped, that link's digital signature will change. This property may be used to monitor a network comprising one more fiber optic links.

With reference to the flowchart in FIG. 7E, this may be done as follows:

First, determine and store the signatures of physical network links that are to be monitored (at 734). This may be done as described above, e.g., by measuring composite optical backscatter signature of each physical network link that is to be monitored, at one or more optical wavelengths. The signatures may be stored in a database, e.g., as described above, and may be considered baseline signatures.

At a later time, the signatures of some or all digital links may be again determined (at 736) using the same measurement techniques used for the stored measurements.

The newly determined signatures (determined at 736) may be compared (at 738) to the previously determined signatures (e.g., to the baseline signatures) in order to detect possible changes in the network configuration. If a change is detected, the changed link may be identified for further investigation. Such a change may be indicative of a security compromise such as an unauthorized tap of the particular link.

As changes are made to the network the baseline signatures should be updated.

As should be appreciated, if no changes are made to a network then its signatures should not change. Accordingly, a changed network configuration may, in a first option, be determined as a function of all of the digital signatures.

The security checking described here may be applied to a subset of connections in the network.

Using Digital Signatures for Quality Control

The digital signature of an optical cable may change, e.g., if the cable is damaged.

In some case, a manufacturer may measure a cable's signature at time of manufacture. The signature may be stored and made available. Then, at or after installation, the stored signature may be checked for signs of damage. If a cable's signature does not match the manufacturer's stored signature for that cable, the mismatch may indicate damage to the cable. As should be appreciated, this approach may be used for quality control and to prevent the inadvertent installation of damaged cables.

### Matching Algorithm

A matching algorithm (e.g., 512 in FIG. 5) is used to identify which constituent fiber optic cable segments are part of the composite trace. Reverse trace search is a content-based trace retrieval query technique that involves providing the system with a sample trace that it will then use as the basis to search the database.

In a typical example, a content-based trace retrieval process is implemented and executed by the processor (e.g., processing unit 510 in FIG. 5). The search results are obtained by comparing traces using computer pattern matching and correlation techniques. The trace matching system is an identification system: the system recognizes an individual trace segment within the total composite trace by searching the template database for matches. It may conduct one-to-many comparisons to establish the identity of the traces (i.e. the fiber optic cable serial number), and how the traces are interconnected or concatenated end-to-end.

### Discussion

Aspects of the present invention have applications in data centers, metro networks, long-haul networks, fiber-to-the-home, and even sensor networks such as those in aircraft. Any system that consists of large number of fiber optic connections benefit from the ability to monitor the connectivity state and its performance. In some cases, the health and performance of composite electrical and optical cables can be monitored in real time by monitoring the optical backscatter signals of one or more of the constituent fiber optic cables. In highly secure networks, this technique can be further used to detect unauthorized intrusion and/or tapping into the physical network.

### Computing

The applications, services, mechanisms, operations, and acts shown and described above are implemented, at least in part, by software running on one or more computers.

Programs that implement such methods (as well as other types of data) may be stored and transmitted using a variety of media (e.g., computer readable media) in a number of manners. Hard-wired circuitry or custom hardware may be used in place of, or in combination with, some or all of the software instructions that can implement the processes of various embodiments. Thus, various combinations of hardware and software may be used instead of software only.

One of ordinary skill in the art will readily appreciate and understand, upon reading this description, that the various processes described herein may be implemented by, e.g., appropriately programmed general purpose computers, special purpose computers and computing devices. One or more such computers or computing devices may be referred to as a computer system.

FIG. 8 is a schematic diagram of a computer system 800 upon which embodiments of the present disclosure may be implemented and carried out.

According to the present example, the computer system 800 includes a bus 802 (i.e., interconnect), one or more processors 804, a main memory 806, read-only memory 808, removable storage media 810, mass storage 812, and one or more communications ports 814. Communication port(s) 814 may be connected to one or more networks (not shown) by way of which the computer system 800 may receive and/or transmit data.

As used herein, a “processor” means one or more microprocessors, central processing units (CPUs), computing devices, microcontrollers, digital signal processors, or like devices or any combination thereof, regardless of their architecture. An apparatus that performs a process can include, e.g., a processor and those devices such as input devices and output devices that are appropriate to perform the process.

Processor(s) 804 can be any known processor, such as, but not limited to, an Intel® Itanium® or Itanium 2® processor(s), AMD® Opteron® or Athlon MP® processor(s), or Motorola® lines of processors, and the like. Communications port(s) 814 can be any of an Ethernet port, a Gigabit port using copper or fiber, or a USB port, and the like. Communications port(s) 814 may be chosen depending on a network such as a Local Area Network (LAN), a Wide Area Network (WAN), or any network to which the computer system 800 connects. The computer system 800 may be in communication with peripheral devices (e.g., display screen 816, input device(s) 818) via Input/Output (I/O) port 820.

Main memory 806 can be Random Access Memory (RAM), or any other dynamic storage device(s) commonly known in the art. Read-only memory (ROM) 808 can be any static storage device(s) such as Programmable Read-Only Memory (PROM) chips for storing static information such as instructions for processor(s) 804. Mass storage 812 can be used to store information and instructions. For example, hard disk drives, an optical disc, an array of disks such as Redundant Array of Independent Disks (RAID), or any other mass storage devices may be used.

Bus 802 communicatively couples processor(s) 804 with the other memory, storage, and communications blocks. Bus 802 can be a PCI/PCI-X, SCSI, a Universal Serial Bus (USB) based system bus (or other) depending on the storage devices used, and the like. Removable storage media 810 can be any kind of external storage, including hard-drives, floppy drives, USB drives, Compact Disc-Read Only Memory (CD-ROM), Compact Disc-Re-Writable (CD-RW), Digital Versatile Disk-Read Only Memory (DVD-ROM), etc.

Embodiments herein may be provided as one or more computer program products, which may include a machine-readable medium having stored thereon instructions, which may be used to program a computer (or other electronic devices) to perform a process. As used herein, the term “machine-readable medium” refers to any medium, a plurality of the same, or a combination of different media, which participate in providing data (e.g., instructions, data structures) which may be read by a computer, a processor or a like device. Such a medium may take many forms, including but not limited to, non-volatile media, volatile media, and transmission media. Non-volatile media include, for example, optical or magnetic disks and other persistent memory. Volatile media include dynamic random-access memory, which typically constitutes the main memory of the computer. Transmission media include coaxial cables, copper wire and fiber optics, including the wires that comprise a system bus coupled to the processor. Transmission media may include or convey acoustic waves, light waves, and electromagnetic emissions, such as those generated during radio frequency (RF) and infrared (IR) data communications.

The machine-readable medium may include, but is not limited to, floppy diskettes, optical discs, CD-ROMs, magneto-optical disks, ROMs, RAMs, erasable programmable read-only memories (EPROMs), electrically erasable programmable read-only memories (EEPROMs), magnetic or optical cards, flash memory, or other type of media/machine-readable medium suitable for storing electronic instructions. Moreover, embodiments herein may also be downloaded as a computer program product, wherein the program may be transferred from a remote computer to a requesting computer by way of data signals embodied in a carrier wave or other propagation medium via a communication link (e.g., modem or network connection).

Various forms of computer readable media may be involved in carrying data (e.g. sequences of instructions) to a processor. For example, data may be (i) delivered from RAM to a processor; (ii) carried over a wireless transmission medium; (iii) formatted and/or transmitted according to numerous formats, standards or protocols; and/or (iv) encrypted in any of a variety of ways well known in the art.

A computer-readable medium can store (in any appropriate format) those program elements which are appropriate to perform the methods.

As shown, main memory 806 is encoded with application(s) 822 that support(s) the functionality as discussed herein (the application(s) 822 may be an application(s) that provides some or all of the functionality of the services/mechanisms described herein, e.g., VR sharing application 230, FIG. 2). Application(s) 822 (and/or other resources as described herein) can be embodied as software code such as data and/or logic instructions (e.g., code stored in the memory or on another computer readable medium such as a disk) that supports processing functionality according to different embodiments described herein.

During operation of one embodiment, processor(s) 804 accesses main memory 806 via the use of bus 802 in order to launch, run, execute, interpret, or otherwise perform the logic instructions of the application(s) 822. Execution of application(s) 822 produces processing functionality of the service related to the application(s). In other words, the process(es) 824 represent one or more portions of the application(s) 822 performing within or upon the processor(s) 804 in the computer system 800.

For example, process(es) 824 may include an matching algorithm process corresponding to the matching algorithm 514 (FIG. 5).

It should be noted that, in addition to the process(es) 824 that carries(carry) out operations as discussed herein, other embodiments herein include the application(s) 822 itself (i.e., the un-executed or non-performing logic instructions and/or data). The application(s) 822 may be stored on a computer readable medium (e.g., a repository) such as a disk or in an optical medium. According to other embodiments, the application(s) 822 can also be stored in a memory type system such as in firmware, read only memory (ROM), or, as in this example, as executable code within the main memory 806 (e.g., within Random Access Memory or RAM). For example, application(s) 822 may also be stored in removable storage media 810, read-only memory 808, and/or mass storage device 812.

Those skilled in the art will understand that the computer system 800 can include other processes and/or software and hardware components, such as an operating system that controls allocation and use of hardware resources.

As discussed herein, embodiments of the present invention include various steps or acts or operations. A variety of these steps may be performed by hardware components or may be embodied in machine-executable instructions, which may be used to cause a general-purpose or special-purpose processor programmed with the instructions to perform the operations. Alternatively, the steps may be performed by a combination of hardware, software, and/or firmware. The term “module” refers to a self-contained functional component, which can include hardware, software, firmware, or any combination thereof.

One of ordinary skill in the art will readily appreciate and understand, upon reading this description, that embodiments of an apparatus may include a computer/computing device operable to perform some (but not necessarily all) of the described process.

Embodiments of a computer-readable medium storing a program or data structure include a computer-readable medium storing a program that, when executed, can cause a processor to perform some (but not necessarily all) of the described process.

Where a process is described herein, those of ordinary skill in the art will appreciate that the process may operate without any user intervention. In another embodiment, the process includes some human intervention (e.g., a step is performed by or with the assistance of a human).

Although embodiments hereof are described using an integrated device (e.g., a smartphone), those of ordinary skill in the art will appreciate and understand, upon reading this description, that the approaches described herein may be used on any computing device that includes a display and at least one camera that can capture a real-time video image of a user. For example, the system may be integrated into a heads-up display of a car or the like. In such cases, the rear camera may be omitted.

### CONCLUSION

As used herein, including in the claims, the phrase “at least some” means “one or more,” and includes the case of only one. Thus, e.g., the phrase “at least some ABCs” means “one or more ABCs,” and includes the case of only one ABC.

The term “at least one” should be understood as meaning “one or more,” and therefore includes both embodiments that include one or multiple components. Furthermore, dependent claims that refer to independent claims that describe features with “at least one” have the same meaning, both when the feature is referred to as “the” and “the at least one.”

As used in this description, the term “portion” means some or all. So, for example, “A portion of X” may include some of “X” or all of “X.” In the context of a conversation, the term “portion” means some or all of the conversation.

As used herein, including in the claims, the phrase “based on” means “based in part on” or “based, at least in part, on,” and is not exclusive. Thus, e.g., the phrase “based on factor X” means “based in part on factor X” or “based, at least in part, on factor X.” Unless specifically stated by use of the word “only,” the phrase “based on X” does not mean “based only on X.”

As used herein, including in the claims, the phrase “using” means “using at least,” and is not exclusive. Thus, e.g., the phrase “using X” means “using at least X.” Unless specifically stated by use of the word “only,” the phrase “using X” does not mean “using only X.”

As used herein, including in the claims, the phrase “corresponds to” means “corresponds in part to” or “corresponds, at least in part, to,” and is not exclusive. Thus, e.g., the phrase “corresponds to factor X” means “corresponds in part to factor X” or “corresponds, at least in part, to factor X.” Unless specifically stated by use of the word “only,” the phrase “corresponds to X” does not mean “corresponds only to X.”

In general, as used herein, including in the claims, unless the word “only” is specifically used in a phrase, it should not be read into that phrase.

As used herein, including in the claims, the phrase “distinct” means “at least partially distinct.” Unless specifically stated, distinct does not mean fully distinct. Thus, e.g., the phrase, “X is distinct from Y” means that “X is at least partially distinct from Y,” and does not mean that “X is fully distinct from Y.” Thus, as used herein, including in the claims, the phrase “X is distinct from Y” means that X differs from Y in at least some way.

It should be appreciated that the words “first” and “second” in the description and claims are used to distinguish or identify, and not to show a serial or numerical limitation. Similarly, the use of letter or numerical labels (such as “(a),” “(b),” and the like) are used to help distinguish and/or identify, and not to show any serial or numerical limitation or ordering.

No ordering is implied by any of the labeled boxes in any of the flow diagrams unless specifically shown and stated. When disconnected boxes are shown in a diagram the activities associated with those boxes may be performed in any order, including fully or partially in parallel.

As used herein, including in the claims, singular forms of terms are to be construed as also including the plural form and vice versa, unless the context indicates otherwise. Thus, it should be noted that as used herein, the singular forms “a,” “an,” and “the” include plural references unless the context clearly dictates otherwise.

Throughout the description and claims, the terms “comprise,” “including”, “having”, and “contain” and their variations should be understood as meaning “including but not limited to” and are not intended to exclude other components.

The present invention also covers the exact terms, features, values and ranges etc. in case these terms, features, values and ranges etc. are used in conjunction with terms such as about, around, generally, substantially, essentially, at least etc. (i.e., “about 3” shall also cover exactly 3 or “substantially constant” shall also cover exactly constant).

Use of exemplary language, such as “for instance”, “such as”, “for example” and the like, is merely intended to better illustrate the invention and does not indicate a limitation on the scope of the invention unless so claimed. Any steps described in the specification may be performed in any order or simultaneously, unless the context clearly indicates otherwise.

All of the features and/or steps disclosed in the specification can be combined in any combination, except for combinations where at least some of the features and/or steps are mutually exclusive. In particular, preferred features of the invention are applicable to all aspects of the invention and may be used in any combination.

Reference numerals have just been referred to for reasons of quicker understanding and are not intended to limit the scope of the present invention in any manner.

While the invention has been described in connection with what is presently considered to be the most practical and preferred embodiments, it is to be understood that the invention is not to be limited to the disclosed embodiment, but on the contrary, is intended to cover various modifications and equivalent arrangements included within the spirit and scope of the appended claims.

We claim:

1. A method comprising:
obtaining a digital signature for an optical fiber cable; and
using the digital signature to identify the optical fiber cable, wherein
the digital signature comprises an optical backscatter signature for the optical fiber cable at one or more wavelengths, from one or both ends.

2. The method of claim 1, wherein the digital signature is stored in a database of digital signatures, a particular digital signature of said digital signatures corresponding to a particular optical fiber cable.

3. The method of claim 2, wherein each digital signature in the database is unique in the database.

4. The method of claim 3, wherein a given digital signature in the database comprises an optical backscatter signature for a corresponding given optical fiber cable at one or more wavelengths, from one or both ends of said given optical fiber.

5. The method of claim 3, further comprising:
for an optical link comprising a sequence of multiple optical fiber cable segments connected in series, using digital signatures in the database to determine the optical fiber cable segments in the optical link.

6. The method of claim 5, wherein the database also includes one or more connector digital signatures of a corresponding one or more fiber optic connectors, and where the method further comprises also using at least one connector digital signature to determine the optical fiber cable segments in the optical link.

7. A method comprising:
using a plurality of digital optical fiber cable signatures to determine or evaluate aspects of an interconnected fiber optic network,
wherein a given signature comprises an optical backscatter signature for a corresponding given optical fiber cable at one or more wavelengths, from one or both ends of said given optical fiber.

8. The method of claim 7, wherein said aspects of said interconnected fiber optic network comprise one or more of: a physical topology of said interconnected fiber optic network; and/or performance of said interconnected fiber optic network.

9. The method of claim 7, further comprising:
providing a database of said plurality of digital optical fiber cable signatures.

10. The method of claim 7, wherein said using also uses one or more connector digital signatures of a corresponding one or more fiber optic connectors to determine or evaluate aspects of said interconnected fiber optic network.

11. A method of determining a signature of an optical link, said optical link comprising a sequence of multiple optical fiber cable segments connected in series, the method comprising:
measuring an optical backscatter signature for the optical link at one or more wavelengths, from one or both ends;
matching the signature of the optical link to signatures of optical fiber cable segments stored in a memory; and
based on said matching, determining the sequence of multiple optical fiber cable segments along the optical link.

12. The method of claim 11, wherein the signatures of optical fiber cable segments stored in the memory were determined by:
measuring an optical backscatter signature for a plurality of individual optical fiber cable segment at one or more wavelengths, from one or both ends; and
storing signatures of individual optical fiber cable segments and their associated unique identifiers and related metadata in memory.

13. The method of claim 11, wherein the signature of the optical link comprises a unique backscatter signature.

14. The method of claim 11, further comprising:
measuring an optical backscatter signature for each optical port of a plurality of optical transceiver elements at one or more wavelengths, and storing signatures of individual optical transceiver elements and their associated unique identifiers and related metadata in the memory.

15. The method of claim 14, further comprising:
matching the signature of the optical link to the signature of a transceiver element stored in the memory; and,
based on said matching, determining the identifier of a transceiver element terminating the optical link.

16. The method of claim 12, further comprising:
determining physical lengths of the optical link and of the cable segments, and storing the physical lengths in the metadata.

17. The method of claim 12, further comprising:
determining optical insertion loss of the optical link and the cable segments, and storing in the metadata.

18. The method of claim 12, further comprising:
determining optical return loss of the optical link and the cable segments and storing in the metadata.

19. The method of claim 12 wherein the optical link further comprises one or more fiber optic connectors.

20. The method of claim 19, wherein said determining also uses one or more connector digital signatures of a corresponding one or more fiber optic connectors to determine the sequence of multiple optical fiber cable segments along the optical link.

21. A method comprising:
obtaining a signature of an optical link, said optical link comprising a connected sequence of components, said components including multiple optical fiber cable segments; and
based on said signature of said optical link and a plurality of component signatures, determining components that comprise the optical link, wherein
said a plurality of component signatures were determined for a corresponding plurality of components, and where said components comprise a first plurality of optical fiber cable segments.

22. The method of claim 21, wherein the optical link is connected to or comprises a transceiver having at least one optical port, and wherein the components include a second plurality of optical ports, and wherein the component signatures comprise signatures of the second plurality of optical ports.

23. The method of claim 22, further comprising:
determining an identifier or a transceiver element terminating the optical link using said signatures of the second plurality of optical ports.

24. The method of claim 21, wherein obtaining the signature of an optical link comprises:
measuring an optical backscatter signature for the optical link at one or more wavelengths, from one or both ends.

25. The method of claim 24, wherein the component signature for a particular component of the plurality of components was determined by:
measuring an optical backscatter signature for the particular component at one or more wavelengths, from one or both ends.

26. The method of claim 21 wherein the optical link further comprises one or more fiber optic connectors.

27. The method of claim 26, wherein said determining also uses one or more connector digital signatures of a corresponding one or more fiber optic connectors to determine components that comprise the optical link.

28. A method of determining or discovering a physical topology of a highly interconnected network of optical fiber cables, the method comprising:
configuring one or more automated optical switches to connect one or more optical backscatter measurement devices to the optical fiber cables of the interconnected network;
measuring and storing a sampled representation of an optical backscatter signature of each optical fiber cable at one or more optical wavelengths;
measuring and storing a sampled representation of a composite optical backscatter signature of optical fiber cables in the network at one or more optical wavelengths; and
correlating the composite optical backscatter signature with stored optical backscatter signatures for constituent optical fiber cables, to identify a cable and the cable's location within the interconnected network.

29. The method of claim 28, wherein said correlating identifies each cable and their location within the interconnected network.

30. The method of claim 28, further comprising:
generating a physical connectivity map of the network.

31. The method of claim 30 further comprising:
generating a heat map of insertion loss for the interconnected network.

32. The method of claim 28, wherein at least some of said optical fiber cables are connected by a corresponding one or more fiber optic connectors.

33. The method of claim 28, wherein the one or more optical wavelengths are in spectral windows about 1310 nm, 1550 nm or 1625 nm.

34. The method of claim 28, wherein an optical backscatter signature is measured with a spatial resolution along the fiber of 0.1 mm to 10 mm.

35. A method of troubleshooting network connectivity along a physical network link after a network is deployed, the network link comprising constituent cable segments, the method comprising:
measuring a composite optical backscatter signature of the link at one or more optical wavelengths and storing the signature and associated metadata in a database;
correlating the composite optical backscatter signature with a stored database of backscatter signatures for the constituent cable segments, to determine an end-to-end, serial relationship of constituent cable segments along the link, stored as connectivity data;
comparing the connectivity data with previously stored connectivity data;
based on said comparing,
(i) identifying a location along the link at which the connectivity data changed from a previous measurement; and
(ii) determining if a change corresponds to a particular constituent cable segment connector, an insertion loss event, a cut, bend or stressed cable segment.

36. The method of claim 35, further comprising:
determining an optical insertion loss of the link from the optical backscatter signature.

37. The method of claim 36, further comprising:
determining an optical return loss of the link from the optical backscatter signature.

38. The method of claim 36, wherein the link also comprises one or more fiber optic connectors.

39. The method of claim 38, and wherein said correlating also uses one or more connector digital signatures of a corresponding one or more fiber optic connectors to determine the end-to-end, serial relationship of constituent cable segments along the link.

40. A method of diagnosing swapped transmit and receive lines in a transmission link, the method comprising:
measuring a composite optical backscatter signature of a physical network link at one or more optical wavelengths;
correlating the composite optical backscatter signature with a stored database of backscatter signatures of optical transceiver elements; and,
based on said correlating, identifying whether a distal port is the transmit or receive line.

41. The method of claim 40, wherein the database comprises backscatter signatures of ports of optical transceiver elements.

42. The method of claim 40, further comprising:
based on said measuring, if measurement indicates that the transmit and receive lines are reversed, instructing an automated patch-panel attached to the physical network link to swap transmit and receive lines.

43. The method of claim 40, wherein the link also comprises one or more fiber optic connectors.

44. The method of claim 43, wherein said correlating also uses one or more connector digital signatures of a corresponding one or more fiber optic connectors to identify whether the distal port is the transmit or receive line.

45. A method comprising:
(A) for at least one particular link of a plurality of physical network links in a network, each link comprising one or more constituent optical cable segments, determining a corresponding composite optical backscatter signature;
(B) comparing one or more backscatter signatures determined in (A) to previously determined backscatter signatures for the network; and,
(C) based on the comparing in (B), determining whether there has been a change in connectivity or configuration of the network.

46. The method of claim 45, further comprising:
identifying a location or link within the network that has changed.

47. The method of claim 45, wherein the link also comprises one or more fiber optic connectors.

48. A method comprising:
(A) obtaining a digital signature for an optical fiber cable; and
(B) comparing the digital signature obtained in (A) to a previously determined digital signature for the optical fiber cable; and,
(C) based on the comparing in (B), determining whether the fiber optic cable has been modified or damaged since the previously determined digital signature was determined.

49. The method of claim 48, wherein the digital signature comprises an optical backscatter signature for the optical fiber cable at one or more wavelengths, from one or both ends.

50. The method of claim 48, wherein the previously determined digital signature was determined and/or provided by the optical fiber cable manufacturer.

51. An automated fiber optic cable discovery and mapping system comprising:
a multiplicity of fiber optic cables connected serially and end-to-end;
a processing unit;
an optical reflectometer unit;
a database comprising cable reflection records, each cable reflection record including a unique identifier and a reflection trace comprising optical reflection strength as a function of longitudinal distance along the cable; and
a matching algorithm to identify location and end-to-end relationship of cables based on matching reflection traces.

52. The system of claim 51, further comprising:
an optical switching system to selectively connect the optical reflectometer unit onto any of the multiplicity of fiber optic cables.

53. The system of claim 52, wherein the optical switching system comprises a robotic fiber optic patch-panel system providing passive, low insertion loss physical fiber optic connections between the optical reflectometer unit and any of the multiplicity of fiber optic cables.

54. A data center interconnect system providing high bandwidth data transmission links between network elements including one or more of the network elements including routers, switches, servers, storage devices, optical fiber and optical transport equipment, wherein interconnect system comprises:
a multiplicity of optical fiber links;
at least some of said optical fiber links are comprised of a corresponding multiplicity of cable segments;
each cable segment characterized by a unique Rayleigh backscatter signature represented by a two dimensional array of optical reflection values as a function of longitudinal distance from a first connector of the cable segment and extending to a second connector of the cable segment; and
the backscatter signature and associated metadata for each cable segment stored within a database.

55. The system of claim 54, further comprising:
a reflectometer selectively connectable to one of the links, wherein the reflectometer measures the Rayleigh backscatter signature along the entire link.

56. The system of claim 55, further comprising:
a processing unit to match the Rayleigh backscatter signature along the entire link to the cable segments and to determine end-to-end connectivity of said cable segments.

57. The system of claim 54, wherein at least some of said optical fiber links also comprises one or more corresponding fiber optic connectors.
